(19) United States
(12) Patent Application Publication
(10) Pub. No.: US 2015/0023032 A1
(43) Pub. Date: Jan. 22, 2015

(54) CURRENT CONTROLLING APPARATUS FOR AUTOMOTIVE LAMP

(71) Applicant: SL Corporation, Daegu (KR)

(72) Inventor: Doo Woon Kang, Gyungsan (KR)

(73) Assignee: SL Corporation

(21) Appl. No.: 14/330,663

(22) Filed: Jul. 14, 2014

(30) Foreign Application Priority Data
Jul. 16, 2013 (KR) 10-2013-0083648

(51) Int. Cl. H01S 3/13; F21S 8/10

(52) U.S. Cl. CPC H01S 3/1305; F21S 48/1145; F21S 48/1225
USPC 362/466

(57) ABSTRACT

A current controlling apparatus for an automotive lamp is provided that adjusts a current applied to the automotive lamp that uses laser light as a light source to adjust the intensity of the laser light. The automotive lamp includes a light source that generates laser light and a phosphor excited by the generated laser light to generate light of a predetermined color. A minor is configured to transmit therethrough a first portion of the generated laser light while reflecting a second portion of the generated laser light. A light receiver is configured to receive reflected laser light from the minor and output an output signal based on an intensity of the received laser light. In addition, a controller is configured to detect an intensity of the generated laser light based on the output signal and adjust a current applied to the light source based on results of the detection.

### CROSS-REFERENCE TO RELATED APPLICATION

This application claims priority to Korean Patent Application No. 10-2013-0083648 filed on Jul. 16, 2013, which application is incorporated herein by reference.

### BACKGROUND

1. Field of the Invention

The invention relates to a current controlling apparatus for an automotive lamp, and more particularly, to a current controlling apparatus for an automotive lamp, that controls a current applied to the automotive lamp that uses laser light as a light source, and thus controls the intensity of the laser light.

2. Description of the Related Art

Many vehicles today are equipped with lamps for illuminating nearby objects during night-time driving (e.g., driving with low lighting conditions) or signaling nearby vehicles or pedestrians as to a state of driving. For example, headlights and fog lights are mainly for illuminating purposes, and turn signal lights, taillights, brake lights, and side marker lights are mainly for signaling purposes. There are rules and regulations that state specification and installation criteria that automotive lamps should follow to properly perform their functions.

Further, light-emitting diodes (LEDs) or laser diodes have been used as light sources for automotive lamps, and research has been conducted regarding method of using light generated through excitation of a phosphor with light emitted from a light source as another light source. Laser light emitted from laser diodes generally has substantially high luminance and strong directivity and thus may be easily collected without loss. Accordingly, laser diodes can provide light with higher luminance and higher definition than LEDs. However, since the performance of laser diodes may vary depending on temperature, the intensity of laser light generated by laser diodes may fluctuate even when the laser diodes are provided with a uniform current.

Automotive lamps are supposed to maintain a uniform brightness level. However, fluctuations in the intensity of laser light generated by laser diodes may cause confusion to the drivers of nearby vehicles or nearby pedestrians as to the driving status of the vehicles equipped with the laser diodes. Additionally, laser light emitted outwardly from automotive lamps even in the event of a car collision may cause damage to the eyes of nearby pedestrians or even loss of lives. Therefore, a method is needed to more uniformly maintain the intensity of laser light emitted from laser diodes and adjust the intensity of the laser light according to the state of a vehicle or the state of the surrounding environment of the vehicle.

### SUMMARY

Exemplary embodiments of the invention provide a current controlling apparatus for an automotive lamp, configured to detect the intensity of laser light emitted from a light source and adjust the level of a current applied to the light source based on the results of the detection to generate laser light with more uniform intensity. In addition, exemplary embodiments of the invention provide a current controlling apparatus for an automotive lamp (e.g., a vehicle lamp), configured to adjust the intensity of a current applied to a light source according to the state of a vehicle or the state of the surrounding environment of the vehicle to secure a clearer view for the driver and to protect nearby drivers and pedestrians from glare, damage to the eyes, or even loss of lives. However, exemplary embodiments of the invention are not restricted to those set forth herein. The above and other exemplary embodiments of the invention will become more apparent to one of ordinary skill in the art to which the invention pertains by referencing the detailed description of the invention given below.

According to an exemplary embodiment of the invention, a current controlling apparatus for an automotive lamp may include: a light source configured to generate laser light; a phosphor configured to be excited by the generated laser light to generate light of a predetermined color; a minor configured to transmit therethrough some of the generated laser light while reflecting some of the generated laser light; a light receiver configured to receive reflected laser light from the mirror and output an output signal based on an intensity of the received laser light; and a controller configured to detect an intensity of the generated laser light based on the output signal and adjust a current applied to the light source based on results of the detection.

According to the exemplary embodiments, some of (e.g., a portion of the entire emitted light) laser light emitted from a light source toward a phosphor may be reflected to properly detect the intensity of the emitted laser light, and the level of a current applied to the light source may be adjusted based on the results of the detection. As a result, an automotive lamp may generate laser light with more uniform intensity while maintaining more uniform brightness. Accordingly, it may be possible to prevent car accidents or even loss of lives that may be caused by nearby vehicles or pedestrians' confusion as to the driving status of a vehicle with the automotive lamp. In addition, the level of the current applied to the light source may also be adjusted based on the state of the vehicle or the state of the surrounding environment of a vehicle. Accordingly, it may be possible to protect the drivers of nearby vehicles or nearby pedestrians against glare or any damage to the eyes that may be caused by laser light emitted from the vehicle even in the event of a car accident.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary diagram of a current controlling apparatus for an automotive lamp according to a first exemplary embodiment of the invention;

FIGS. 2 and 3 are exemplary diagrams of a light guide member according to an exemplary embodiment of the invention;

FIG. 4 is an exemplary diagram of a current controlling apparatus for an automotive lamp, according to a second exemplary embodiment of the invention;

FIGS. 5 and 6 are exemplary diagrams of a current controlling apparatus for an automotive lamp, according to a third exemplary embodiment of the invention; and

FIG. 7 is an exemplary diagram of a current controlling apparatus for an automotive lamp, according to a fourth exemplary embodiment of the invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Advantages and features of the invention and methods of accomplishing the same may be understood more readily by reference to the following detailed description of exemplary embodiments and the accompanying drawings. The invention may, however, be embodied in many different provides and should not be construed as being limited to the embodiments set forth herein. Rather, these exemplary embodiments are provided so that this disclosure will be thorough and complete and will fully convey the concept of the invention to those skilled in the art, and the invention will only be defined by the appended claims. Like reference numerals refer to like elements throughout the specification.

The exemplary embodiments and features of the invention and methods for achieving the exemplary embodiments and features will be apparent by referring to the exemplary embodiments to be described in detail with reference to the accompanying drawings. However, the invention is not limited to the exemplary embodiments disclosed hereinafter, but can be implemented in diverse provides. The matters defined in the description, such as the detailed construction and elements, are nothing but specific details provided to assist those of ordinary skill in the art in a comprehensive understanding of the invention, and the invention is only defined within the scope of the appended claims.

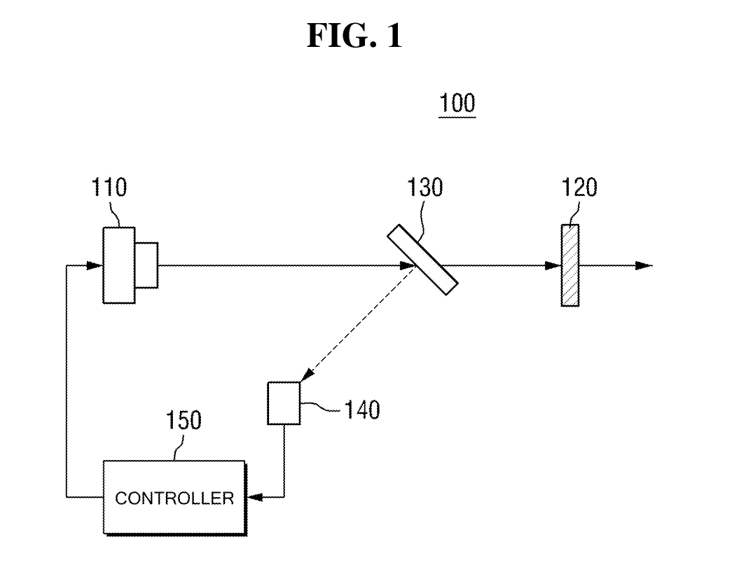

Exemplary embodiments will hereinafter be described with reference to the accompanying drawings. FIG. 1 is an exemplary diagram of a current controlling apparatus for an automotive lamp (e.g., a vehicle lamp), according to a first exemplary embodiment of the invention. Referring to FIG. 1, a current controlling apparatus 100 may include a light source 110, a phosphor 120, a minor 130, a light receiver 140 and a controller 150.

The light source 110 may be a source of excitation light configured to excite the phosphor 120. A laser diode may be used as the light source 110. In the first exemplary embodiment, the light source 110 may be configured to generate blue laser light with a peak wavelength range of about 440 nm to about 490 nm, but the invention is not limited thereto. In other words, the type of the light source 110 or the type of light generated by the light source 110 may vary depending on the color of light that the current controlling apparatus 100 or the phosphor 120 is required to generate.

The phosphor 120 may be excited by laser light generated by the light source 110, and may thus be configured to generate light of a predetermined color. In the first exemplary embodiment, the phosphor 120 may be configured to generate white light that a typical automotive lamp is commonly required to generate, but the invention is not limited thereto. In other words, the color of light generated by the light source 110 and the color of light generated by the phosphor 120 may vary depending on the color of light that an automotive lamp is required to generate, which may vary depending on the purpose of use of the current controlling apparatus 100. The type of the phosphor 120 may vary depending on the color of the laser light generated by the light source 110. For example, in response to the current controlling apparatus 100 being required to emit white light and the light source 110 generating blue laser light with a peak wavelength range of about 440 nm to about 490 nm, a yellow phosphor with a peak wavelength range of about 560 nm to about 590 nm may be used as the phosphor 120 to cause the phosphor 120 to emit white light.

In the first exemplary embodiment, the light source 110 may be configured to generate blue laser light, and a yellow phosphor may be used as the phosphor 120. However, the invention is not limited to this exemplary embodiment. In other words, various phosphors, such as blue, green and red phosphors, or a combination thereof may be used as the phosphor 120. A transmissive phosphor, that transmits therethrough light generated by excitation caused by laser light, and a reflective phosphor, that reflects light generated by excitation caused by laser light, may be used as the phosphor 120. More specifically, in response to the phosphor 120 being implemented as a transmissive phosphor, the phosphor 120 may be configured to absorb laser light and may emit light that corresponds to the color thereof. In response to the phosphor 120 being implemented as a reflective phosphor, the phosphor 120 may be provided with a reflective surface formed on one side thereof to reflect light generated by the phosphor 120 using the reflective surface.

The minor 130 may be implemented as a reflective mirror configured to transmit therethrough some of the laser light generated by the light source 110 while reflecting some of the laser light generated by the light source 110. That is, a first portion of the entire laser light may be transmitted through the reflective mirror and a second portion of the entire laser light may be reflected. In the first exemplary embodiment, various reflective minors may be used as the mirror 130 provided the requirements that the amount of laser light arriving at the phosphor 120 from the light source 110 through the minor 130 be sufficient to comply with regulations regarding the purpose of use of the current controlling apparatus 100 and also be greater than the amount of light reflected from the minor 130.

In the first exemplary embodiment, the transmittance of the minor 130 may be configured to be greater than the reflectance of the mirror 130 since the greater the reflectance of the mirror 130, the less the amount of laser light applied to the phosphor 120 and the less likely it is to comply with the regulations regarding the purpose of use of the current controlling apparatus 100. The light receiver 140 may be implemented as a photo diode configured to receive laser light reflected from the minor 130, and may be configured to output an output signal that corresponds to the intensity of the received laser light. For example, the intensity of the output signal of the light receiver 140 may vary depending on the intensity or the direction of the light received by the light receiver 140.

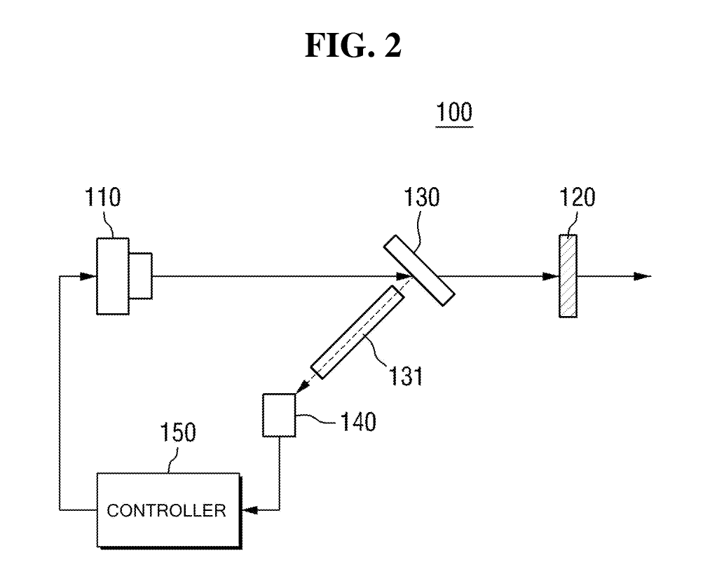

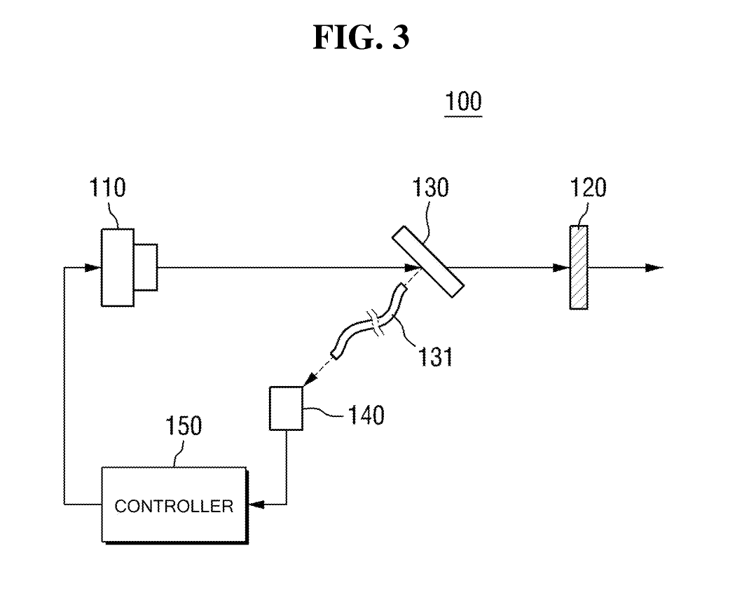

In the first exemplary embodiment, laser light reflected from the minor 130 may be directly received by the light receiver 140 since laser light generally has substantially strong directivity, but the invention is not limited thereto. In other words, laser light reflected by the minor 130 may be guided by a light guide member and may then be received by the light receiver 140. More specifically, referring to FIGS. 2 and 3, laser light reflected by the minor 130 may be guided by a light guide member 131 and may then be received by the light receiver 140. FIG. 2 illustrates an example of the current controlling apparatus 100 using a light guide as the light guide member 131, and FIG. 3 illustrates an example of the current controlling apparatus 100 using an optic fiber as the light guide member 131.

When the light guide member 131 is provided to guide laser light reflected from the minor 130 to allow the laser light to be received by the light receiver 140, as illustrated in FIGS. 2 and 3, the degree of design freedom may be improved with regard to the current controlling apparatus 100 since the light receiver 140 is not required to be disposed in the vicinity of the minor 130. The light guide member 131 may not be provided when the light receiver 130 is required to directly receive light reflected from the mirror 130 due to the structural properties of the current controlling apparatus 100.

The controller 150 may be configured to detect the intensity of laser light generated by the light source 110 based on the intensity of the output signal of the light receiver 140, and may be configured to adjust the level of a current applied to the light source 110 based on the results of the detection to cause the light source 110 to generate laser light with more uniform intensity. More specifically, the performance of a laser diode may vary according to temperature variations. Accordingly, in response to a laser diode being used as the light source 110, the intensity of light generated by the light source 110 may vary depending on ambient temperature, (i.e., the temperature of the surroundings of the current controlling apparatus 100), even when a more uniform current is applied to the light source 110. The controller 150 may be configured to detect the intensity of laser light based on the output signal of the light receiver 140, which reflects how much reflected laser light from the minor 130 is received by the light receiver 140, and adjust the level of a current applied to the light source 110. Accordingly, the light source 110 may be configured to generate laser light with a more uniform intensity.

In the first exemplary embodiment, the controller 150 may be configured to adjust the level of a current applied to the light source 110 based on the intensity of the output signal of the light receiver 140, but the invention is not limited thereto. In other words, the controller 150 may be configured to adjust the level of a current applied to the light source 110 based on the state of a vehicle (not illustrated) or the state of the surroundings of the vehicle.

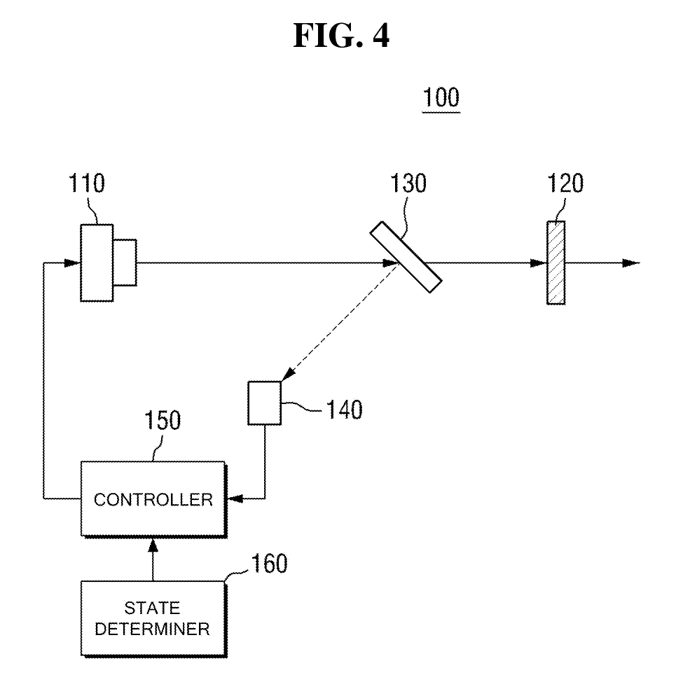

FIG. 4 is an exemplary diagram of a current controlling apparatus for an automotive lamp, according to a second exemplary embodiment of the invention. Referring to FIG. 4, a current controlling apparatus 100, like its counterpart of the first exemplary embodiment, may include a light source 110, a phosphor 120, a mirror 130, a light receiver 140 and a controller 150. The current controlling apparatus 100 may also include a state determiner 160 may be configured to determine the state of a vehicle (not illustrated) or the state of the surroundings of the vehicle. The light source 110, the phosphor 120, the minor 130, the light receiver 140 and the controller 150 are similar to their respective counterparts of the first exemplary embodiment, and thus, detailed descriptions thereof will be omitted. The state determiner 160 may include various sensors to determine the state of the vehicle or the state of the surroundings of the vehicle, for example, a collision detection sensor, an illumination sensor, a temperature sensor, and a humidity sensor, and may be configured to detect a collision of the vehicle with an obstacle or determine illumination and weather conditions in the surroundings of the vehicle. The state determiner 160 may be operated by the controller 150.

In the second exemplary embodiment, a determination may be made regarding the state of the vehicle or the state of the surroundings of the vehicle since laser light emitted outward from the vehicle during a car collision may cause damage to the eyes of nearby pedestrians, and since failure to consider illumination and weather conditions in the surroundings of the vehicle may lead to failure to secure a sufficiently clear view for the driver or may cause glare to the drivers of nearby vehicles or nearby pedestrians. In the second exemplary embodiment, the controller 150 may be configured to adjust the level of a current applied to the light source 110 based on the intensity of laser light received by the light receiver 140 and also based on the results of the determination performed by the state determiner 160 regarding the state of the vehicle or the state of the surroundings of the vehicle.

In the first and second exemplary embodiments, the minor 130 may be disposed between the light source 110 and the phosphor 120. Since the controller 150 may be configured to adjust the level of a current applied to the light source 110 based on the intensity of laser light received by the light receiver 140, the state of the vehicle or the state of the surroundings of the vehicle, the location of the minor 130 between the light source 110 and the phosphor 120 may facilitate detection of the intensity of laser light generated by the light source 110 regardless of whether the phosphor 120 is a reflective phosphor or a transmissive phosphor.

More specifically, in response to a transmissive phosphor being used as the phosphor 120, the phosphor 120 may be configured to transmit therethrough light generated by excitation caused by laser light. Accordingly, even when the minor 130 is not present, the intensity of laser light generated by the light source 110 may be properly detected based on laser light reflected from the phosphor 120. Further, in response to a reflective phosphor configured to reflect light generated by excitation caused by laser light, being used as the phosphor 120, it may be difficult to properly laser light reflected from the phosphor 120. However, in the first and second exemplary embodiments, since the mirror 130 may be disposed between the light source 110 and the phosphor 120, the intensity of laser light generated by the light source 110 may be more easily detected regardless of whether a transmissive phosphor or a reflective phosphor is used as the phosphor 120.

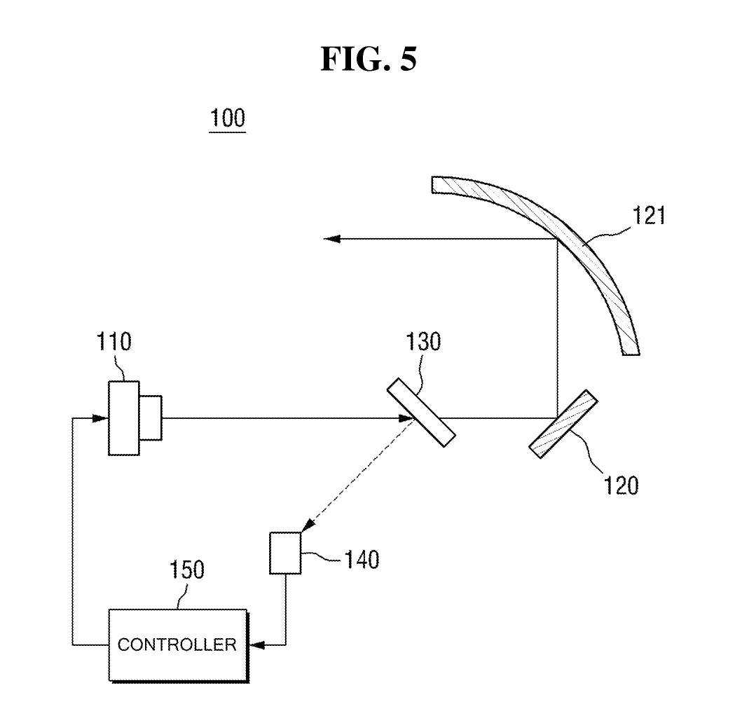

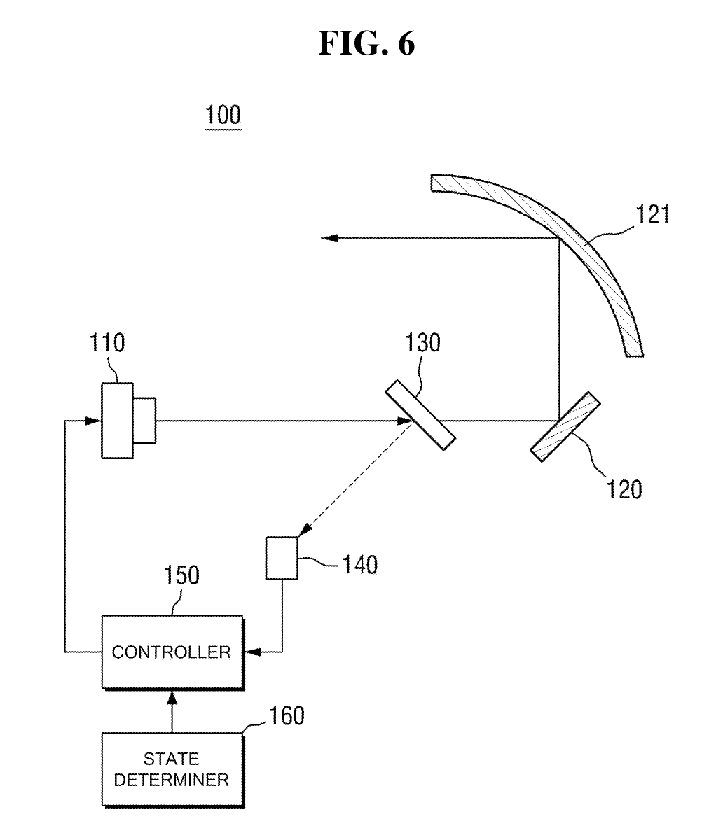

FIGS. 5 and 6 are exemplary diagrams of a current controlling apparatus for an automotive lamp, according to a third exemplary embodiment of the invention. More specifically, FIGS. 5 and 6 illustrate an example of a current controlling apparatus using a reflective phosphor as a phosphor 120. Referring to FIG. 5, a current controlling apparatus 100, like its counterpart of the first or second exemplary embodiment, may include a light source 110, a phosphor 120, a mirror 130, a light receiver 140 and a controller 150. In the third exemplary embodiment, the phosphor 120 may be a reflective phosphor configured to reflect light generated by excitation caused by laser light.

In the third exemplary embodiment, the current controlling apparatus 100 may also include a reflector 121 configured to reflect light generated by the phosphor 120 to travel forward (e.g., the driving direction of the vehicle) or toward the exterior of a vehicle (not illustrated), but the invention is not limited thereto. In other words, light generated by the phosphor 120 may travel forward or toward the exterior of the vehicle without the aid of the reflector 121, and may then be emitted outward from the vehicle by a lens (not illustrated) or a light guide member (not illustrated).

Due to the presence of the mirror 130 between the light source 110 and the phosphor 120, the light receiver 140 may be configured to receive some reflected laser light from the mirror 130 and output an output signal based on the received laser light. Accordingly, even when a reflective phosphor is used as the phosphor 120, as illustrated in FIG. 5, the controller 150 may be configured to properly detect the intensity of laser light based on the output signal of the light receiver 140 and adjust the level of a current applied to the light source 110 based on the results of the detection. Additionally, referring to FIG. 6, even when a reflective phosphor is used as the phosphor 120, the controller 150, like its counterpart of FIG. 4, may be configured to properly adjust the level of a current applied to the light source 110 based on the intensity of an output signal of the light receiver 140 and also based on the results of determination performed by a state determiner 160 regarding the state of the vehicle or the state of the surroundings of the vehicle.

In the first through third exemplary embodiments, the transmittance of the minor 130 may be configured to be greater than the reflectance of the mirror 130, and the controller 150 may be configured to detect the intensity of laser light based on how much (e.g., an amount of) of reflected laser light from the minor 130 is received by the light receiver 140. However, the invention is not limited to the first through third exemplary embodiments. In other words, the controller 150 may be configured to receive laser light transmitted through the minor 130, and detect the intensity of laser light based on the received laser light.

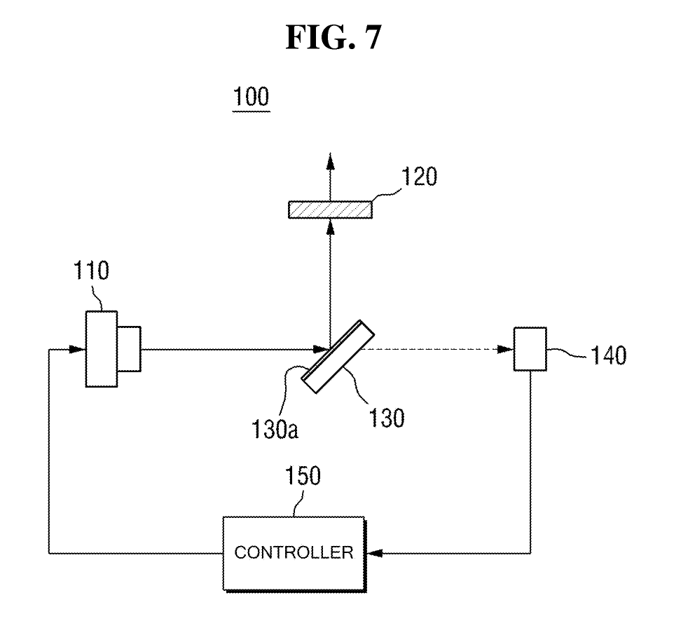

FIG. 7 is an exemplary diagram of a current controlling apparatus for an automotive lamp, according to a fourth exemplary embodiment of the invention. More specifically, FIG. 7 illustrates an example of a current controlling apparatus detecting the intensity of laser light based on laser light received through a minor. Referring to FIG. 7, a current controlling apparatus 100, like its counterpart of the first, second or third exemplary embodiment, may include a light source 110, a phosphor 120, a mirror 130, a light receiver 140 and a controller 150. The light source 110, the phosphor 120, the mirror 130, the light receiver 140 and the controller 150 are similar to their respective counterparts of the first, second or third exemplary embodiment, and thus, detailed descriptions thereof will be omitted. In the fourth exemplary embodiment, the reflectance of the mirror 130 may be configured to be greater than the transmittance of the mirror 130. As a result, laser light reflected from the minor 130 may reach the phosphor 120, and laser light transmitted through the minor 130 may be received by the light receiver 140.

In the fourth exemplary embodiment, for the mirror 130 to have greater reflectance than the transmittance thereof, a reflective film 130a may be formed on a surface of the mirror 130 upon which laser light emitted from the light source 110 is incident, as illustrated in FIG. 7, but the invention is not limited thereto. In other words, the minor 130 may be formed to have greater reflectance than the transmittance thereof in the first place; in which case, the reflective film 130a may be optional. The reflective film 130a may be disposed on one surface of the minor 130, or may be attached onto one surface of the minor 130 by an adhesive. In the fourth exemplary embodiment, like in the second exemplary embodiment, the current controlling apparatus 100 may also include a state determiner 160, and may be configured to adjust the level of a current applied to the light source 110 based on the output signal of the light receiver 140 and also based on the results of determination performed by the state determiner 160 regarding the state of a vehicle (not illustrated) or the state of the surroundings of the vehicle.

While the invention has been particularly shown and described with reference to exemplary embodiments thereof, it will be understood by those of ordinary skill in the art that various changes in provide and detail may be made therein without departing from the spirit and scope of the invention as defined by the following claims. The exemplary embodiments should be considered in a descriptive sense only and not for purposes of limitation.

What is claimed is:

1. A current controlling apparatus for a vehicle lamp, comprising:
a light source configured to generate laser light;
a phosphor configured to be excited by the generated laser light to generate light of a predetermined color;
a minor configured to transmit therethrough a first portion of the generated laser light while reflecting a second portion of the generated laser light;
a light receiver configured to receive reflected laser light from the mirror and output an output signal based on an intensity of the received laser light; and
a controller configured to detect an intensity of the generated laser light based on the output signal and adjust a current applied to the light source based on results of the detection.

2. The current controlling apparatus of claim 1, wherein the phosphor is configured to transmit therethrough or reflect the light of the predetermined color.

3. The current controlling apparatus of claim 2, further comprising:
a reflector configured to reflect light reflected from the phosphor to travel toward an exterior of a vehicle, in response to the phosphor reflecting the light of the predetermined color.

4. The current controlling apparatus of claim 1, wherein the light receiver is a photo diode.

5. The current controlling apparatus of claim 1, further comprising:
a state determiner configured to determine a state of a vehicle or a state of the surroundings of the vehicle.

6. The current controlling apparatus of claim 5, wherein the state determiner includes at least one of a group consisting of: a collision detection sensor, an illumination sensor, a temperature sensor, and a humidity sensor.

7. The current controlling apparatus of claim 1, wherein the minor is configured to have a greater transmittance than the reflectance thereof with respect to the generated laser light.

8. The current controlling apparatus of claim 1, wherein the minor is further configured to be provided with a reflective film, which is formed on one surface of the mirror and has predetermined transmittance and reflectance.

9. The current controlling apparatus of claim 1, further comprising:
a light guide member configured to guide the reflected laser light from the minor to travel toward the light receiver.

10. The current controlling apparatus of claim 9, wherein the light guide member is an optic fiber or a light guide.
